(19) United States
(12) Patent Application Publication
(10) Pub. No.: US 2026/0365003 A1
(43) Pub. Date: Nov. 19, 2026

(54) FULLY-EMBEDDED BED COVER FOR A PICKUP TRUCK

(71) Applicant: Yinxian Chen, Hangzhou (CN)

(72) Inventors: Yinxian Chen, Hangzhou (CN); Yingjie Sun, Hangzhou (CN)

(21) Appl. No.: 19/663,329

(22) Filed: Apr. 30, 2026

Related U.S. Application Data
(63) Continuation of application No. 18/181,923, filed on Mar. 10, 2023, now abandoned.

(51) Int. Cl. B60J 7/14; B60J 7/00; B60J 7/19; B60P 7/02

(52) U.S. Cl. CPC B60J 7/141; B60J 7/0084; B60J 7/198; B60P 7/02

(57) ABSTRACT

The present invention discloses a fully-embedded bed cover of a pickup truck, including a panel body connected to the cargo hopper, wherein the panel body is connected to the cargo hopper by a dual interlink lock system and a guide rail supporting bar system, wherein the panel body includes a first panel, a second panel, a third panel and a large front bar, one end of the first panel is connected to the large front bar, the other end of the first panel is connected to a second panel by a rotating shaft system.

This application is a continuation application of U.S. Application No. 18/181,923, filed on Mar. 10, 2023, the content of which is incorporated herein by reference.

### TECHNICAL FIELD

This invention is relevant to automobile accessories, especially a fully embedded bed cover.

### BACKGROUND OF THE INVENTION

The cargo hopper of the pickup truck (also known as a sedan truck) is used for carrying goods. Since the cargo hopper is open, people invented the bed cover to avoid wetting the goods in the cargo hopper in rainy and snowy weather. Install the bed cover on the pickup truck's cargo hopper and use the cover to prevent the goods in the cargo hopper from getting wet by rain.

Current structure of the bed cover as described below, using hinges and other structures to install several reversible bed cover panels in a frame, but there are still gaps between the cover, water droplets will still penetrate the cargo hopper from the gap, and the bed cover is an external structure, which often has poor consistency with the cargo hopper.

### SUMMARY OF THE INVENTION

The purpose of the present invention is to provide a fully-embedded bed cover, which, by improving the structure of the cover, results in better consistency and better waterproofing.

In order to solve the above-mentioned problems of the prior art, the technical solution adopted in the present invention is

The purpose of the present invention is to provide a fully-embedded bed cover, which, by improving the structure of the bed cover (including the improvement of the panel body and the improvement of the connection between panel bodies), results in better consistency and better waterproofing.

In order to solve the above-mentioned problems of the prior art, the technical solution used in the present invention is:

A fully embedded bed cover, includes a panel body connected to a cargo hopper, the panel body is connected to the cargo hopper by a dual interlink lock system and a guide rail support bar system, the panel body includes a first panel, a second panel, a third panel and a large front bar, one end of the first panel is connected to the large front bar, the other end of the first panel is connected to the second panel by a rotating shaft system, the second panel is connected to the third panel by a rotating shaft system, the end of the third panel away from the second panel is connected to the rear bar with locking system.

The guide rail support bar system is connected to the cargo hopper.

the rotating shaft system includes a large rotating bar, a small rotating bar, an intermediate bar and an intermediate bar rubber strip, the large rotating bar and small rotating bar are respectively connected to both ends of the intermediate bar by means of an intermediate bar rubber strip, the large rotating bar includes a large rotating bar groove for connecting the panels and a large rotating bar connecting groove for connecting the intermediate bar rubber strip, the small rotating bar includes a small rotating bar groove for connecting the panels and a small rotating bar connecting groove for connecting the intermediate bar rubber strip, both ends of the intermediate bar are provided with an intermediate bar groove for connecting the intermediate bar rubber strip, the intermediate bar rubber strip includes a pressing plate, a bulge and two restriction sections.

Further, the small rotating bar is connected to a sealing plate, the sealing plate is arranged at the opening side of the small rotating bar connection groove, the side of the sealing plate away from the small rotating bar connecting groove is connected with a extrusion rod, the side of the sealing plate near the small rotating bar connecting groove is provided with sealing bumps; the intermediate bar is connected to a sealing plate, the sealing plate is arranged at the opening side of the intermediate bar groove, the side of the sealing plate away from the intermediate bar groove is connected with a extrusion rod, the side of the sealing plate near the intermediate bar groove is provided with sealing bumps; the large rotating bar is connected to a sealing plate, the sealing plate is arranged at the opening side of the large rotating bar connecting groove, the side of the sealing plate away from the large rotating bar connecting groove is connected with a extrusion rod, the side of the sealing plate near the large rotating bar connecting groove is provided with sealing bumps. By setting the extrusion rod and sealing plate, when the intermediate bar rubber strip is connected to the large rotating bar, the intermediate bar, and the small rotating bar, by pressing the extrusion rod, the sealing plate clamps the intermediate rod rubber strip, and fit with the sealing bumps to play a good waterproof effect.

Further, the dual interlink lock system is used to connect the panel body with the guide rail support bar system, the dual interlink lock system includes a profile connected to the panel body, both ends of the profile are respectively connected with a lock assembly, the two lock assemblies are connected by a steel wire rope, the lock assembly includes a locating block and a lock, the locating block is connected to the profile, the lock is slidably connected to the locating block, both ends of the steel wire rope are respectively connected to the two locks, the panel body is designed as a three-section structure, part of the panel body can be selectively opened according to needs, which is convenient to use, since the bed cover cannot be directly connected with the existing cargo hopper, a guide rail support bar system is added to the edge of the existing cargo hopper to facilitate the connection of the bed cover, since the dual interlink lock system includes two locks, the two locks are connected by a steel wire rope, when pulling the steel wire rope, the two locks shrink at the same time to release the bed cover, by setting the dual interlink lock system, make the bed cover open easily.

Further, the locating block includes a bottom plate, the bottom plate is provided with a mounting cavity, the lock includes a connecting block, a connecting rod, a lock bolt and a spring, the lock bolt and connecting block are connected by the connecting rod, the spring is sleeved on the connecting rod, by setting the locating block, the lock is slidingly connected to the locating block, using the locating block as a support to limit the lock, not only facilitates pulling the lock to open the bed cover, but also to automatically reset, which is convenient for operation, the mounting cavity is provided with a limit plate, the connecting rod passes through the limit plate, both ends of the spring are respectively connected to the lock bolt and the limit plate, by setting a limit plate, using the limit plate to limit the spring, when pulling the steel wire rope to drive the lock bolt shrink, under the action of the limit plate, the spring elongates and drives the lock bolt reset, the lock is a detachable structure, the connecting rod and the lock bolt are connected by threads, the lock is designed as a split structure, when installing, the connecting rod is passed by the end of the limit plate away from the lock bolt, then connected to the spring, finally the connecting rod is connected to the lock bolt, at the same time the spring is connected to the limit plate and the lock bolt, the bottom plate is also provided with a mounting hole for passing through the steel wire rope, by setting the mounting hole, the steel wire rope is guided to ensure that the steel wire rope moves smoothly.

Further, the mounting groove is arranged between the pressing plate and the bulge, the two restriction sections are symmetrically connected on both sides of the bulge, the intermediate bar rubber strip is set between the large rotating bar and the intermediate bar and between the intermediate bar and the small rotating bar to avoid direct contact between the large rotating bar, the intermediate bar and the small rotating bar, effectively reducing collision and providing good protection for the rotating shaft system, by setting the large rotating bar connecting groove, the small rotating bar connecting groove and the intermediate bar groove, fit them with the restriction section to make the whole more compact, by setting the large rotating bar, small rotating bar and intermediate bar, and setting the intermediate bar rubber strip between the rotating bar and the intermediate bar bracket, improving the sealing performance, not only play a good waterproof effect, but also ensure the smoothness of the panel body when rotating, the large front bar is connected with a support pad.

Further, the guide rail support bar system includes a guide rail, a front bar fixing block and a clamping unit, the guide rail is connected to the cargo hopper through the clamping unit, the end of the guide rail near the first panel is connected with a front bar fixing block, the front bar fixing block is provided with a connecting hole, the front bar fixing block is connected to the large front bar through a connecting nut and a connecting screw, the connecting screw passes through the large front bar and the connecting hole, and is fixed by the connecting nut, the clamping unit 79 connected the guide rail with the cargo hopper to ensure the stability of the guide rail and prevent problems such as collapse. By setting the connecting nut and connecting screw, the large front bar is connected to the guide rail stably, the guide rail includes a support plane, a drainage groove and a limiting bevel, the drainage groove and limiting bevel are respectively connected to both sides of the support plane, the support plane is connected to the first rubber strip, the limiting bevel is used to limiting the lock bolt. By setting the support plane, provide efficient support to the panel body, by setting the drainage groove, the water flowing down the plate body will all gather in the drainage groove and be discharged along it, the side of the guide rail away from the support plane is connected with a second rubber strip, when closing, the bed cover presses the first rubber strip to improve the sealing of the cover, the clamping unit clamps the second rubber strip to achieve a good anti-slip effect.

Further, the guide rail support bar system further includes a support bar, a mounting end, a fixing bracket, and a support bar fixing block, one end of the support bar is connected to the rail through the support bar fixing block, the other end of the support bar is connected to the mounting end, the fixing bracket is connected to the guide rail, the fixing bracket is used to support the support bar.

The beneficial effect of the present invention is that the present invention constitutes a closed cover with a large front bar, a rotating shaft system, a rear bar system and a side bar joint, which will not leak and has a high aesthetic appearance and almost flat appearance of the car body.

The beneficial effect of the present invention is that the present invention constitutes a closed cover with a large front bar, a rotating shaft system, a rear bar system and a side bar joint, which will not leak and has a high aesthetic appearance and almost flat appearance of the car body.

### DESCRIPTION OF FIGURES

FIG. 1 is a structural schematic diagram 1 of the present invention.

FIG. 2 is a structural schematic diagram 2 of the present invention.

FIG. 3 is a partially enlarged view of part A in FIG. 2.

FIG. 4 is a structural schematic diagram of the guide rail support bar system in FIG. 1

FIG. 5 is a partially enlarged view of part B in FIG. 4.

FIG. 6 is a schematic diagram of the connection of the fixing clamp in the present invention;

FIG. 7 is a structural schematic diagram of the rotating shaft system in FIG. 1

FIG. 8 is a schematic diagram of the connection of the rotating shaft system in FIG. 1

FIG. 9 is a partial connection schematic diagram of the intermediate bar rubber strip in FIG. 8

FIG. 10 is a structural schematic diagram 1 of the lock in FIG. 2

FIG. 11 is a structural schematic diagram 3 of the lock in FIG. 2

FIG. 12 is a structural schematic diagram of the dual interlink lock system.

In the Figure: 11-First panel; 12-Second panel; 13-Third panel; 2-Rotating shaft system; 21-Small rotating bar; 211-Small rotating bar groove; 212-Small rotating bar connecting groove; 213-Small rotating bar limit plate; 22-Intermediate bar; 222-Intermediate bar groove; 23-Large rotating bar; 231-Large rotating bar groove; 232-Large rotating bar connecting groove; 233-Large rotating bar limit plate 234-Extrusion rod; 235-Sealing plate; 24-Side rail joint; 25-Intermediate bar rubber strip; 251-Restriction section; 252-Pressing plate; 253-Bulge; 254-Mounting groove; 3-Rear bar with locking system; 4-Large front bar; 41-Connecting nut; 42-Connecting screw; 43-Connecting hole; 5-Support pad; 6-Dual interlink lock system; 61-Loctaing block; 611-Bottom plate; 612-Mounting hole; 613-Mounting cavity; 614-Convex plate; 615-Limit plate; 62-Lock; 621-Connecting block; 622-Spring; 623-Connecting rod; 624-Lock bolt; 63-Steel wire rope; 7-Guide rail support bar system; 71-Guide rail; 711-Support plane; 712-Drainage groove; 713-Limiting bevel; 714-Mounting plane; 72-Front bar fixing block; 73-Second rubber strip; 74-Support bar; 75-Mounting end; 76-First rubber strip; 77-Fixing bracket; 78-Support bar fixing block; 79-Clamping unit; 791-First clamping piece; 792-Second clamping piece; 7921-Support block; 7922-Tighentening block; 793-Tighentening screw.

### DETAILED DESCRIPTION OF THE INVENTION

The following instruction further explains the invention's concrete implementation method.

In order to enable a clearer understanding of the above-mentioned objects, features and advantages of the present invention, the invention is described in detail below in connection with the accompanying drawings and specific embodiments. It should be noted that the embodiments of the present application and the features in the embodiments can be combined with each other without conflict.

The terms "first," "second," "third," etc. are only used to differentiate the description and should not be understood as indicating or implying relative importance.

In the description of the invention, it should also be noted that, unless otherwise expressly specified and limited, the terms "arranged," "installed," "connected," and "combined" should be understood in a broad sense; for example, it may be a fixing connection, it can also be a detachable connection or an integral connection; it can be a mechanical connection or an electrical connection; it can be a direct connection or an indirect connection through an intermediate media, and it can be internal connection within two components. For those of ordinary skill in this field, the meanings of the above terms in the present invention can be understood in specific situations.

The specific embodiments of the present invention will be described in detail below in connection with the accompanying drawings. It should be understood that the specific embodiments described herein are intended only to illustrate and explain the present invention and are not intended to limit it.

### Embodiment 1.

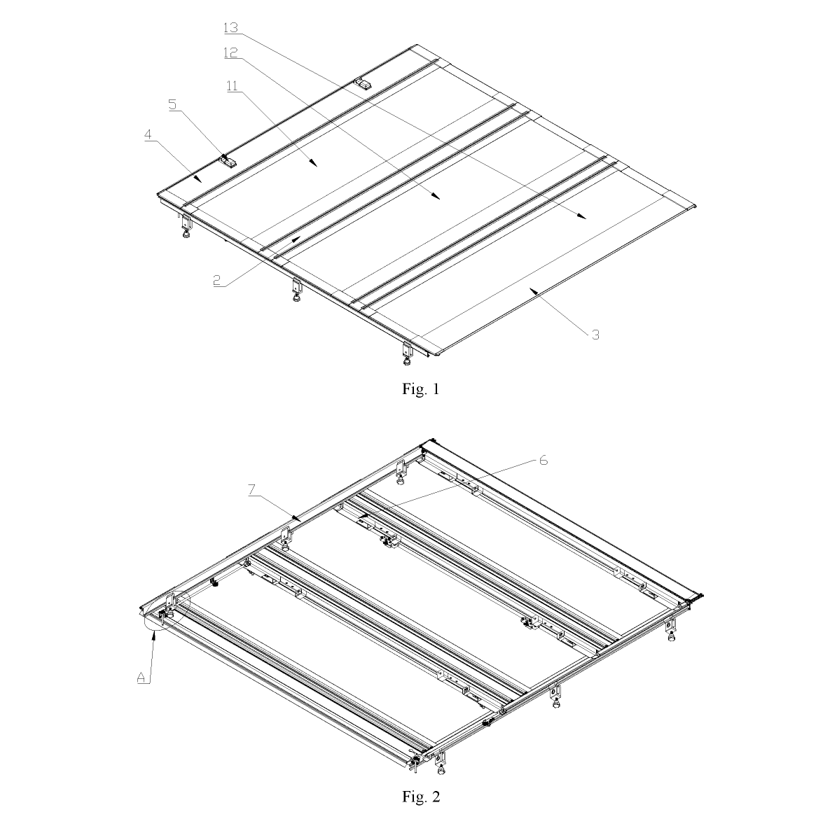

As shown in FIG. 1, 2 and 6-8, a fully embedded bed cover, includes a panel body connected to a cargo hopper, the panel body is connected to the cargo hopper by a dual interlink lock system 6 and a guide rail support bar system 7, the panel group includes a first panel 11, a second panel 12, a third panel 13 and a large front bar 4, one end of the first panel 11 is connected to the large front bar 4, the other end of the first panel 11 is connected to the second panel by a rotating shaft system 2, the second panel 12 is connected to the third panel 13 by a rotating shaft system 2, the end of the third panel 13 away from the second panel 12 is connected to the rear bar with locking system 3.

The guide rail support bar system 7 is connected to the cargo hopper.

The rotating shaft system 2 includes a large rotating bar 23, a small rotating bar 21, an intermediate bar 22 and an intermediate bar rubber strip 25, the large rotating bar 23 and small rotating bar 21 are respectively connected to both ends of the intermediate bar 22 by means of an intermediate bar rubber strip 25.

The large rotating bar 23 includes a large rotating bar groove 231 for connecting the panels and a large rotating bar connecting groove 232 for connecting the intermediate bar rubber strip 25.

The small rotating bar 21 includes a small rotating bar groove 211 for connecting the panels and a small rotating bar connecting groove 212 for connecting the intermediate bar rubber strip 25.

Both ends of the intermediate bar 22 are provided with an intermediate bar groove 222 for connecting the intermediate bar rubber strip 25.

the small rotating bar 21 is connected to a sealing plate 235, the sealing plate 235 is arranged at the opening side of the small rotating bar connection groove 212, the side of the sealing plate 235 away from the small rotating bar connecting groove 212 is connected with an extrusion rod 234, the side of the sealing plate 235 near the small rotating bar connecting groove 212 is provided with sealing bumps.

The intermediate bar 22 is connected to a sealing plat 235e, the sealing plate 235 is arranged at the opening side of the intermediate bar groove 222, the side of the sealing plate 235 away from the intermediate bar groove 222 is connected with an extrusion rod 234, the side of the sealing plate 235 near the intermediate bar groove 222 is provided with sealing bumps.

The large rotating bar 23 is connected to a sealing plate 235, the sealing plate 235 is arranged at the opening side of the large rotating bar connecting groove 232, the side of the sealing plate 235 away from the large rotating bar connecting groove 232 is connected with an extrusion rod 234, the side of the sealing plate 235 near the large rotating bar connecting groove 232 is provided with sealing bumps.

By setting the extrusion rod 234 and sealing plate 235, when the intermediate bar rubber strip 25 is connected to the large rotating bar 23, the intermediate bar 22 and the small rotating bar 21, by press the extrusion rod 234, the sealing plate 235 clamps the intermediate rod rubber strip 25 and fit with the sealing bumps to play a good waterproof effect.

The panel body is designed as a three-section structure, part of the panel body can be selectively opened according to needs, which is convenient to use.

Since the bed cover cannot be directly connected with the existing cargo hopper, a guide rail support bar system 7 is added to the edge of the existing cargo hopper to facilitate the connection of the bed cover

### Embodiment 2

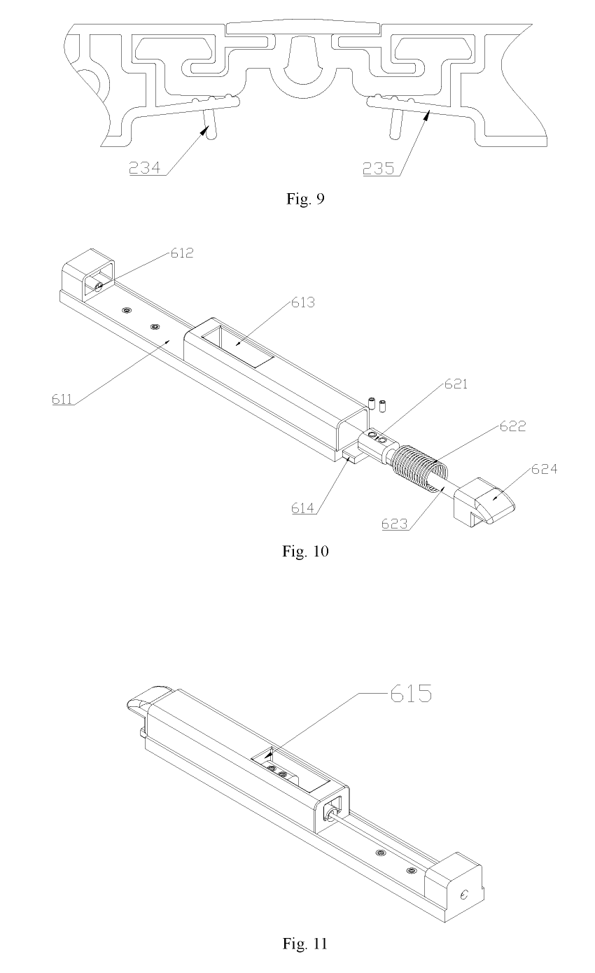

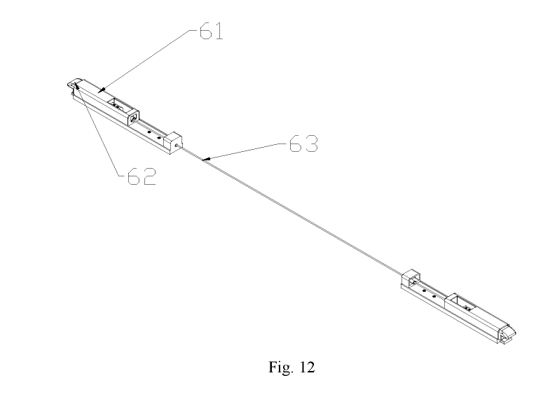

On the basis of Embodiment 1, as shown in FIG. 9-12, the dual interlink lock system 6 is used to connect the panel body with the guide rail support bar system 7, the dual interlink lock system 6 includes a profile connected to the panel body, both ends of the profile are respectively connected with a lock assembly, the two lock assemblies are connected by a steel wire rope 63, the lock assembly includes a locating block 61 and a lock 62, the locating block 61 is connected to the profile, the lock 62 is slidably connected to the locating block 62, both ends of the steel wire rope 63are respectively connected to the two locks 62.

The locating block 61 includes a bottom plate 611, the bottom plate 611 is provided with a mounting cavity 613, the lock 62 includes a connecting block 621, a connecting rod 623, a lock bolt 624 and a spring 622, the lock bolt and connecting block 621 are connected by the connecting rod 623, the spring 622 is sleeved on the connecting rod 623,

Since the dual interlink lock system 6 includes two locks 62, the two locks 62 are connected by a steel wire rope 63, when pulling the steel wire rope 63, the two locks 62 shrink at the same time to release the bed cover, by setting the dual interlink lock system 6, make the bed cover open easily.

By setting the locating block 61, the lock 62 is slidingly connected to the locating block 61, using the locating block 61 as a support to limit the lock, not only facilitates pulling the lock to open the bed cover, but also to automatically reset, which is convenient for operation,

The mounting cavity 613 is provided with a limit plate 615, the connecting rod 623 passes through the limit plate 615, both ends of the spring 622 are respectively connected to the lock bolt 624 and the limit plate 615,

By setting a limit plate 615, using the limit plate 615 to limit the spring 622, when pulling the steel wire rope 63 to drive the lock bolt 624 shrink, under the action of the limit plate 615, the spring 622 elongates and drives the lock bolt 624 reset.

The lock 62 is a detachable structure, connecting rod 623and lock bolt 624 are connected by threads,

The lock 62 is designed as a split structure, when installing, the connecting rod 623 is passed by through the end of the limit plate 614 away from the lock bolt 624, then connected to the spring 622, finally the connecting rod 623 is connected to the lock bolt 624, at the same time the spring 622 is connected to the limit plate 615 and the lock bolt 624.

The bottom plate 611 is also provided with a mounting hole 612 for passing through the steel wire rope 63, the bottom plate 611 is connected with a convex plate 614, which can play a limiting role on the locating block 61 by setting the convex plate 614, the locating block 61 can be limited, the convex plate 614 to connected the profile when using, so that the lock bolt 624 can be well engaged with the profile after being extended, and prevent the lock bolt 624 from extending too long.

By setting the installation hole 612, the steel wire rope 63 is guided to ensure that the steel wire rope 63 moves smoothly.

### Embodiment 3

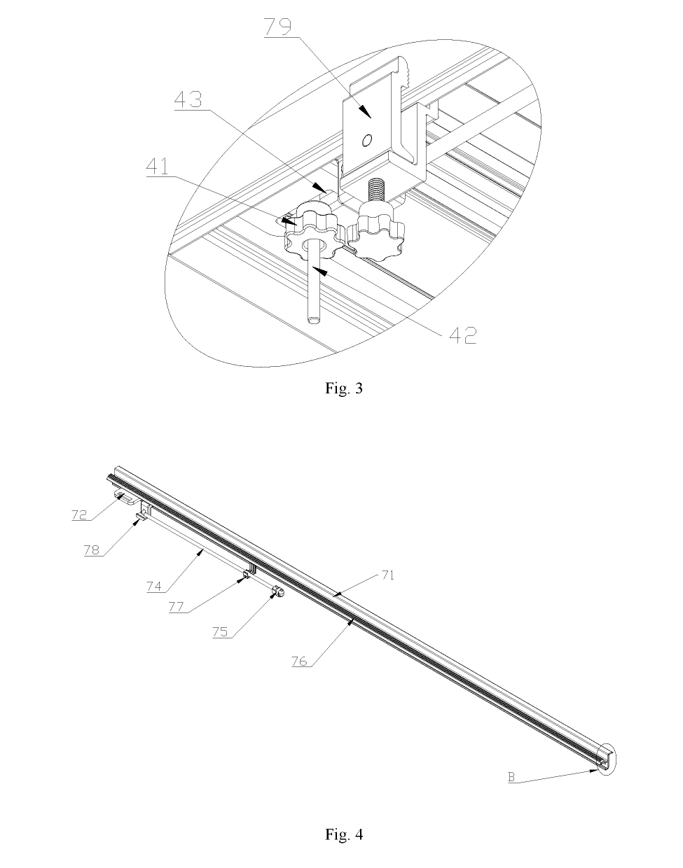

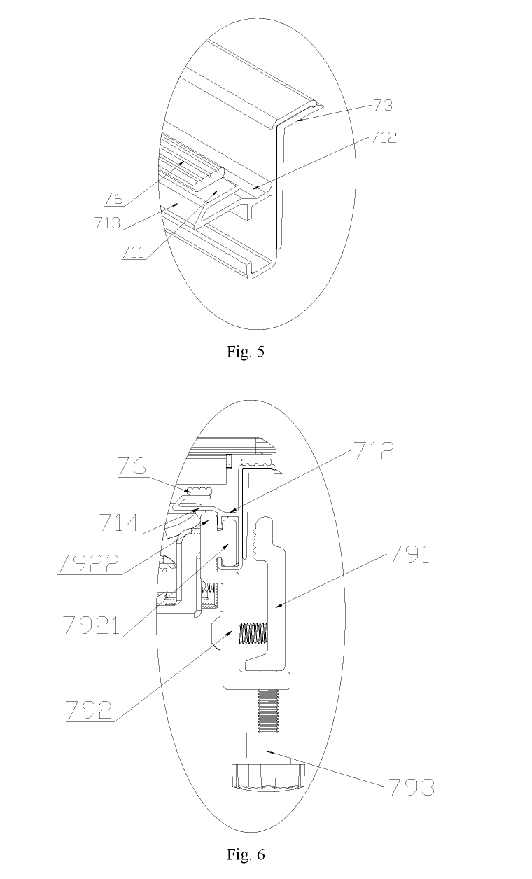

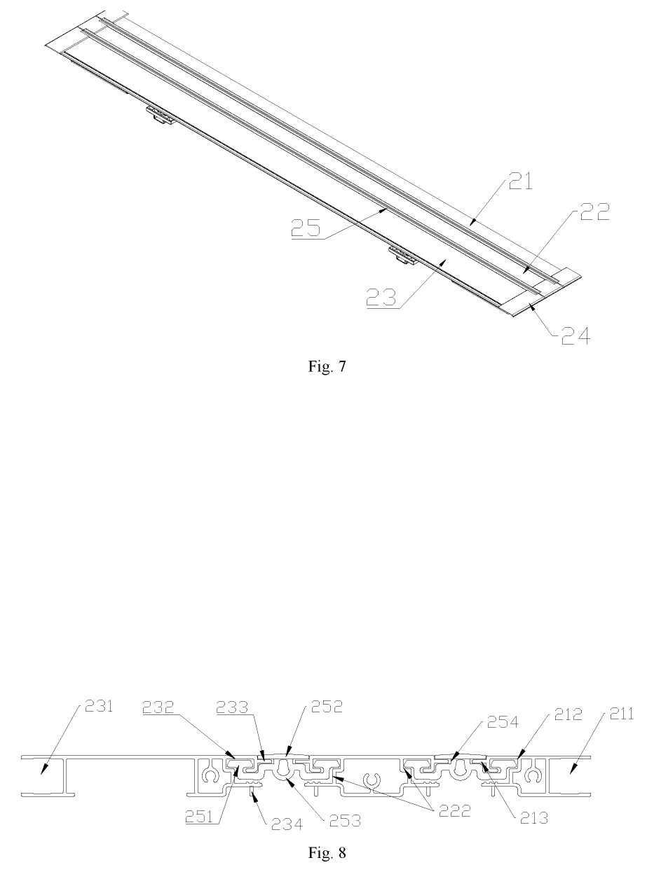

On the basis of embodiment 2, as shown in FIG. 3-5 and 8, intermediate bar rubber strip 25 includes a pressing plate 252, a bulge 253 and two restriction sections 251, the mounting groove 254 is arranged between the pressing plate 252 and the bulge 253, the two restriction sections are symmetrically connected on both sides of the bulge.

The intermediate bar rubber strip 25 is set between the large rotating bar 23 and the intermediate bar 22 and between the intermediate bar 22 and the small rotating bar 21 to avoid direct contact between the large rotating bar 23, the intermediate bar 22 and the small rotating bar 21, effectively reducing collision and providing good protection for the rotating shaft system 2.

By setting the large rotating bar connecting groove 232, the small rotating bar connecting groove 212 and the intermediate bar groove 222, fit them with the restriction section 251 to make the whole more compact,

When installing, the restriction section 251 is first put into the corresponding large rotating bar connecting groove 232, intermediate bar groove 222 and small rotating bar connecting groove212, then the intermediate bar rubber strip 25 is pressed tightly by sealing plate 235, which can ensure that the restriction section 251 will not slip out and play a good waterproof effect.

The large rotating bar 23 is also provided with large rotating bar limit plate 233, the small rotating bar 21 is also provided with small rotating bar limit plate 213.

When the large rotating bar 23 is installed, one of the restriction sections 251 of the intermediate bar 22 extends into the large rotating bar connecting groove 232, the other restriction section 251 extends into the intermediate bar groove 222, while the large rotating bar limit plate 233 extends into the mounting groove 254.

When the small rotating rod 21 is installed, one of the restriction sections 251 of the intermediate bar 22 extends into the small rotating bar connecting groove 212, and the other restriction section 251 extends into the intermediate bar groove 222, while the small rotating rod restriction plate 213 extends into the installation groove 254.

By setting the large rotating bar 23, the small rotating bar 21 and the intermediate bar 22 and setting the intermediate bar rubber strip 25 between the rotating bar and intermediate bar 22 bracket, which not only improve the sealing performance, play a good waterproof effect, and ensure the smoothness of the board body when it turns.

The large front bar 3 is connected with a support pad 5, when the third panel 13, the second panel 12, the first panel 11 folded in turn, the support pad 5 can support the folded panel so that the panel is placed vertically.

### Embodiment 4

On the basis of embodiment 3, as shown in FIG. 3-5, the guide rail support bar system 7 includes a guide rail 71, a front bar fixing block 72 and a clamping unit 79, the guide rail 71 is connected to the cargo hopper through the clamping unit 79, the end of the guide rail 71 near the first panel 11 is connected with a front bar fixing block 72, the front bar fixing block 72 is provided with a connecting hole 43, the front bar fixing block 72 is connected to the large front bar 5 through a connecting nut 41 and a connecting screw 42.

The connecting screw 42 passes through the large front bar 4 and the connecting hole 43 and is fixed by the connecting nut 41.

The clamping unit 79 connected the guide rail 71 with the cargo hopper to ensure the stability of the guide rail and prevent problems such as collapse.

By setting the connecting nut 41 and connecting screw 42, the large front bar 4 is connected to the guide rail 71 stable.

The guide rail 71 includes a support plane 711, a drainage groove 712, a limiting bevel 713 and a mounting plane 714, the mounting plane 714 and the support plane 711 are connected by the limiting bevel 713, the end of the mounting plane 714 away from the limiting bevel 713 is provided with a drainage groove 712, the drainage groove 712 is set lower than the mounting plane 714, the support plane 711 is connected to the first rubber strip 76, the limiting bevel713 is used to limiting the lock bolt 624.

The support plane 711, the limiting bevel 713 and the mounting plane 714 form a "U" shaped structure, the support plane 711 is located above the mounting plane 714.

The support plane 711, the limiting bevel 713 and the installation plane 714 form into a "U"-shaped structure, making the original flat structure into a three-dimensional structure with better force strength, by setting the three-dimensional structure, raise the location of the mounting plane 714, effectively preventing rainwater from spreading over the first rubber strip 76, with better waterproof effect.

By setting the support plane 711, provide efficient support to the panel body, by setting the drainage groove 712, since the drainage groove 712 is set lower than the mounting plane 714, the water flowing down the plate body will all gather in the drainage groove 712 and be discharged along the drainage groove 712.

One side of the guide rail 71 away from the support plane 711 is connected to a second rubber strip 73.

By arranging the first rubber strip 76, when closing, the bed cover presses the first rubber strip 76 to improve the sealing performance of the bed cover, by arranging the second rubber strip 73, the clamping unit 79 clamps the second rubber strip 73 to achieve a good anti-slip effect.

The clamping unit 79 includes a first clamping piece 791, a second clamping piece 792 and a tightening screw 793, the first clamping piece 791 and second clamping piece 792 are connected by bolts, the first clamping piece 791 and second clamping piece 792 are used to connect the guide rail 71 with the cargo hopper, the tightening screw 793 is threaded to the second clamping piece 792, the tightening screw 793 holds the first clamping piece 791 tightly.

The second clamping piece 79 is further provided with a support block 7921, the support block 791 is arranged on the side of the second clamping piece 792 near the first clamping piece 791, the support block 7921 is adapted to the guide rail 71, the support block 7921 extends into the guide rail 71, the support block 7921 extends into the guide rail 71 to support the guide rail 71 to prevent the guide rail 71 from collapsing after long-term use.

The second clamping body 792 is further provided with a tightening block 7922, the tightening block 7922 is used to support the mounting plane 714, after the installation is completed, the mounting plane 714 is pressed against the upper side of the tightening block 7922. When manually pressing the bed cover, the lock 62 will exert a downward pressure on the limiting bevel 713. After long-term use, the limiting bevel 713 will tilt together with the mounting plane 714. After tilting, the bed cover cannot be locked. by providing the tightening block 7922, the tightening block 7922 has a supporting effect on the mounting plane 714, effectively preventing the problem of the mounting plane 714 tilting downward after long-term use.

The guide rail support bar system 7 further includes a support bar 74, a mounting end 75, a fixing bracket 77 and a support bar fixing block 78, one end of the support bar 74 is connected to the guide rail 71 through the support bar fixing block 78, the other end of the support bar 74 is connected to the mounting end 75, the fixing bracket 77 is connected to the guide rail 71, the fixing bracket 77 is used for supporting the support bar 74.

The present invention is not limited to the above-mentioned optional embodiment, anyone can produce various other forms under the inspiration of the present invention. However, regardless of changes in its shape or structure, all technical solutions that fall within the scope defined by the claims of the present invention fall within the scope of protection of the present invention.

What is claimed is:

1. A fully-embedded bed cover, includes a panel body connected to cargo hopper, wherein the panel body is connected to the cargo hopper by a dual interlink lock system (6) and a guide rail support bar system (7), the panel body includes a first panel (11), a second panel (12), a third panel (13) and a large front bar (4), one end of the first panel (11) is connected to the large front bar (4), the other end of the first panel (11) is connected to the second panel (12) by a rotating shaft system (2), the second panel (12) is connected to the third panel (13) by a rotating shaft system (2);
the guide rail support bar system (7) is connected to the cargo hopper;
the rotating shaft system (2) includes a large rotating bar (23), a small rotating bar (21), an intermediate bar (22) and an intermediate bar rubber strip (25), the large rotating bar (23) and small rotating bar (21) are respectively connected to both ends of the intermediate bar (22) by means of an intermediate bar rubber strip (25), the large rotating bar (23) includes a large rotating bar groove (231) for connecting the panels and a large rotating bar connecting groove (25) for connecting the intermediate bar rubber strip, the small rotating bar (21) includes a small rotating bar groove (211) for connecting the panels and a small rotating bar connecting groove (212) for connecting the intermediate bar rubber strip (25), both ends of the intermediate bar (22) are provided with an intermediate bar groove (222) for connecting the intermediate bar rubber strip (25), the intermediate bar rubber strip (25) includes a pressing plate (252), a bulge (253) and two restriction sections (251), a mounting groove (254) is arranged between the pressing plate (252) and the bulge (253), the two restriction sections (251) are symmetrically connected on both sides of the bulge (253).

2. The fully-embedded bed cover according to claim 1, wherein the small rotating bar (21) is connected to a sealing plate (235), the sealing plate (235) is arranged at the opening side of the small rotating bar connecting groove (212), the side of the sealing plate (235) away from the small rotating bar connecting groove(212) is connected with a extrusion rod (234), the side of the sealing plate (235) near the small rotating bar connecting groove (212) is provided with sealing bumps;
the intermediate bar (22) is connected to a sealing plate (235), the sealing plate (235) is arranged at the opening side of the intermediate bar groove (222), the side of the sealing plate (235) away from the intermediate bar groove (222) is connected with an extrusion rod (234), the side of the sealing plate (235) near the intermediate bar groove (222) is provided with sealing bumps;
the large rotating bar (23) is connected to a sealing plate (235), the sealing plate (235) is arranged on the opening side of the large rotating bar groove (232), the side of the sealing plate (235) away from the large rotating bar groove (232) is connected with an extrusion rod (234), the side of the sealing plate (235) near the large rotating bar groove (232) is provided with sealing bumps.

3. The fully-embedded bed cover according to claim 2, wherein the dual interlink lock system (6) includes a profile connected to the panel body, both ends of the profile are respectively connected with a lock assembly, the two lock assemblies are connected to each other by a steel wire rope (63), the lock assembly includes a locating block (61) and a lock (62), the locating block (61) is connected to the profile, the lock (62) is slidingly connected to the locating block (61), both ends of the steel wire rope (63) are respectively connected to the two locks (62);
the locating block (61) includes a bottom plate (611), the bottom plate (611) is provided with a mounting cavity (613), the lock (62) includes a connecting block (621), a connecting rod (623), a lock bolt (624) and a spring (622), the lock bolt and connecting block (621) are connected by a connecting rod (623), the spring (622) is sleeved on the connecting rod (623).

4. The fully-embedded bed cover according to claim 3, wherein the mounting cavity (613) is provided with a limit plate (615), the connecting rod (623) passes through the limit plate (615), both ends of the spring (622) are respectively connected to the lock bolt (624) and the limit plate (615);
the lock (62) is a detachable structure, the connecting rod (623) and the lock bolt (624) are connected by threads.

5. The fully-embedded bed cover according to claim 2, wherein the bottom plate (611) is further provided with a mounting hole (612) for passing through the steel wire rope (63).

6. The fully-embedded bed cover according to claim 1, wherein the guide rail support bar system (7) includes a guide rail (71), a front bar fixing block (72) and a clamping unit (79), the guide rail (71) is connected to the cargo hopper through the clamping unit (79), the end of the guide rail (71) near the first panel (11) is connected with the front bar fixing block (72), the front bar fixing block (72) is provided with a connecting hole (43), the front bar fixing block (72) is connected to the large front bar (4) through a connecting nut (41) and a connecting screw (42).

7. The fully-embedded bed cover according to claim 6, wherein the guide rail (71) includes a support plane (711), a drainage groove (712), a limiting bevel (713) and a mounting plane (714), the mounting plane (714) and the support plane (711) are connected by the limiting bevel (713), the end of the mounting plane (714) away from the limiting bevel (713) is provided with a drainage groove (712), the support plane (711), the limiting bevel (713) and the mounting plane (714) form a "U" shaped structure, the support plane (711) is located above the mounting plane (714).

8. The fully-embedded bed cover according to claim 6, wherein, the connecting screw (42) passes through the large front bar (4) and the connecting hole (43) and is fixed by the connecting nut (41).

9. The fully-embedded bed cover according to claim 7, wherein the clamping unit (79) includes a first clamping piece (791), a second clamping piece (792) and a tightening screw (793), the first clamping piece (791) and second clamping piece (792) are connected by bolts, the tightening screw (793) is threaded to the second clamping piece (792), the tightening screw (793) holds the first clamping piece (791) tightly;
the second clamping piece (792) is provided with a support block (7921) and a tightening block (7922), the support block (7921) is arranged on the side of the second clamping piece (792) near the first clamping piece (791), the support block (7921) is adapted to the guide rail (71), the support block (7921) extends into the guide rail (71), the tightening block (7922) is used to support the mounting plane (714).

10. The fully-embedded bed cover according to claim 7, wherein the support plane (711) is connected with a first rubber strip (76), the guide rail (71) is connected with a second rubber strip (73) on the side away from the support plane (711).
